(19) United States
(12) Patent Application Publication
(10) Pub. No.: US 2006/0000763 A1
(43) Pub. Date: Jan. 5, 2006

(54) Gravity flow carbon block filter

(76) Inventors: Edward B. Rinker, Pleasanton, CA (US); Toni L. Lynch, Pleasanton, CA (US); Ruth W. Chan, Pleasanton, CA (US); Alex Tipton, Pleasanton, CA (US); Bruce D. Saaski, Caldwell, ID (US)

Correspondence Address: THE CLOROX COMPANY, 1221 BROADWAY PO BOX 2351, OAKLAND, CA, 94623, US

(21) Appl. No.: 10/881,517

(22) Filed: Jun. 30, 2004

(51) Int. Cl. B01D 27/02

(52) U.S. Cl. 210/282; 210/502.1

(57) ABSTRACT

A gravity flow carbon block filter comprising approximately 20-90 wt % activated carbon particles having a mean particle size in the range of approximately 90-220 μm, and approximately 10-50 wt % low melt index polymeric material. The low melt index polymeric material can have a melt index less than 1.0 g/10 min or greater than 1.0 g/10 min and a mean particle size in the range of approximately 20-150 μm.

### FIELD OF THE INVENTION

The present invention relates generally to gravity flow filtration systems. More particularly, the invention relates to an improved gravity flow carbon block filter that exhibits a rapid flow rate and high contaminant reduction.

### BACKGROUND

Gravity flow filtration systems are well known in the art. Such systems include pour-through carafes and refrigerator water tanks, which have been developed by The Clorox Company (BRITA®), Culligan™, Rubbermaid™ and Glacier Pure™.

Pour-through carafe systems typically include an upper reservoir for receiving unfiltered water, a lower reservoir for receiving and storing filtered water, and a filtration cartridge with an inlet at its top and outlet at its bottom, through which cartridge, water flows from the upper reservoir to the lower reservoir. The pour-through carafe is sized to be handheld, holds about two liters of water, and may be tipped for pouring filtered water, as in a conventional pitcher or carafe.

Refrigerator tank systems typically include a larger rectangular tank with a spigot for draining filtered water into a glass or pan. Both carafe and refrigerator tank systems use gravity to move the unfiltered water in the top reservoir down through a filtration cartridge and into the lower reservoir where the filtered water remains until it is used.

The filtration cartridge typically employed in pour-through (or gravity flow) systems holds blended media of approximately 20×50 mesh granular activated carbon and either an ion exchange resin, which most typically contains a weak acid cation exchange resin, or a natural or artificial zeolite that facilitates the removal of certain heavy metals, such as lead and copper. Weak acid cation exchange resins can reduce the hardness of the water slightly, and some disadvantages are also associated with their use: first, they require a long contact time to work properly, which limits the flow rate to about one-third liter per minute; second, they take up a large amount of space inside the filter (65% of the total volume) and thus limit the space available for activated carbon.

A further problem associated with blended media of granular carbon and ion exchange resin is that they have limited contaminant removal capability due to particle size and packing geometry of the granules. When large granules are packed together, large voids can form between the granules. As water passes through the packed filter bed, it flows through the voids. Much of the water in the voids does not come into direct contact with a granule surface where contaminants can be adsorbed. Contaminant molecules must diffuse through the water in the voids to granule surfaces in order to be removed from the water. Thus, the larger the voids, the larger the contaminant diffusion distances. In order to allow contaminants to diffuse over relatively long distances, long contact time is required for large granular media to remove a significant amount of contaminant molecules from the water.

Conversely, small granules (i.e., 100-150 μm) form small voids when packed together, and contaminants in water within the voids have small distances over which to diffuse in order to be adsorbed on a granule surface. As a result, shorter contact time between the water and the filter media is required to remove the same amount of contaminant molecules from the water for filter media with small granules than for filter media with large granules.

But there are some drawbacks to using filter media with small granules. Water flow can be slow because the packing of the granules can be very dense, resulting in long filtration times. Also, small granules can be more difficult to retain within the filter cartridge housing.

It would be useful to have a gravity flow filter that exhibits both good water flow rates and high containment reduction.

### SUMMARY

A gravity flow filter block comprising approximately 20-90 wt % activated carbon particles having a mean particle size in the range of approximately 90-220 μm, and approximately 10-50 wt % binder material is provided. The binder material can have a melt index less than 1.0 g/10 min or greater than 1.0 g/10 min and a mean particle size in the range of approximately 20-150 μm.

In one embodiment of the invention, the activated carbon particles are impregnated with either citric acid, a hydroxide, a metal, metal oxide, a metal ion or a salt.

In another embodiment of the invention, the filter contains approximately 10-80 wt % activated carbon particles having a mean particle size in the range of approximately 90-220 μm, approximately 10-50 wt % binder material and approximately 5-40 wt % of an active material. The active material can contain ceramic, zeolite or alumina particles having a mean particle size in the range of approximately 20-100 μm or silica gel.

### BRIEF DESCRIPTION OF THE DRAWINGS

Further features and advantages will become apparent from the following and more particular description of the embodiments of the invention, as illustrated in the accompanying drawings, and in which like referenced characters generally refer to the same parts or elements throughout the views, and in which:

FIG. 1 is a cross-section, side elevation view of a pour-through carafe having a gravity-flow filtration cartridge with a carbon block filter installed therein.

FIG. 2 is a perspective view of one embodiment of a carbon block filter.

FIG. 3 is a top plan view of the carbon block filter shown in FIG. 2.

FIG. 4 is a top plan view of a carbon block filter having a filter sheet disposed proximate the inner wall.

FIG. 5 is a top plan view of a carbon block filter having a filter sheet disposed proximate the outer wall.

FIG. 6 is a top plan view of a carbon block filter having a first filter sheet disposed proximate the inner wall and a second filter sheet disposed proximate the outer wall.

FIG. 7 is a cross-section, side elevation view of an embodiment of a filtration cartridge with a carbon block filter installed therein.

FIG. 8 is a top plan view of the filtration cartridge cover shown in FIG. 7.

FIG. 9 is a bottom plan view of the filtration cartridge cup shown in FIG. 7.

FIG. 10 is a cross-section, side elevation view of an outward water flow path through the filtration cartridge assembly shown in FIG. 7.

FIG. 11 is a cross-section, side elevation view of an embodiment of a filtration cartridge having a carbon block filter installed therein.

FIG. 12 is a top plan view of the filtration cartridge cover shown in FIG. 11.

FIG. 13 is a bottom plan view of the filtration cartridge cup shown in FIG. 11.

FIG. 14 is a cross-section, side elevation view of an inward water flow path through the filtration cartridge shown in FIG. 11.

### DETAILED DESCRIPTION

Before describing the embodiments in detail, it is to be understood that this invention is not limited to particularly exemplified structures, systems or system parameters, as such may, of course, vary. It is also to be understood that the terminology used herein is for the purpose of describing particular embodiments of the invention only, and is not intended to be limiting.

### Definitions

In describing the embodiments of the present invention, the following terms will be employed, and are intended to be defined as indicated below.

The term “activated carbon,” as used herein, means highly porous carbon having a random or amorphous structure. The term “activated carbon” thus includes, but is not limited to, carbon derived from bituminous or other forms of coal, pitch, bones, nut shells, coconut shells, corn husks, polyacrylonitrile (PAN) polymers, charred cellulosic fibers or materials, wood, and the like.

The term “binder,” as used herein, means a material that promotes cohesion of aggregates or particles. The term “binder” thus includes polymeric and/or thermoplastic materials that are capable of softening and becoming “tacky” at elevated temperatures and hardening when cooled. Such thermoplastic binders include, but are not limited to, end-capped polyacetals, such as poly(oxymethylene) or polyformaldehyde, poly(trichloroacetaidehyde), poly(n-valeraldehyde), poly(acetaldehyde), poly(propionaldehyde), and the like; acrylic polymers, such as polyacrylamide, poly(acrylic acid), poly(methacrylic acid), poly(ethyl acrylate), poly(methyl methacrylate), and the like; fluorocarbon polymers, such as poly(tetrafluoroethylene), perfluorinated ethylene-propylene copolymers, ethylene-tetrafluoroethylene copolymers, poly(chlorotrifluoroethylene), ethylene-chlorotrifluoroethylene copolymers, poly(vinylidene fluoride), poly(vinyl fluoride), and the like; polyamides, such as poly(6-aminocaproic acid) or poly(.epsilon.-caprolactam), poly(hexamethylene adipamide), poly(hexamethylene sebacamide), poly(11-aminoundecanoic acid), and the like; polyaramides, such as poly(imino-1,3-phenyleneiminoisophthaloyl) or poly(m-phenylene isophthalamide), and the like; parylenes, such as poly-p-xylylene, poly(chloro-p-xylylene), and the like; polyaryl ethers, such as poly(oxy-2,6-dimethyl-1,4-phenylene) or poly(p-phenylene oxide), and the like; polyaryl sulfones, such as poly(oxy-1,4-phenylenesulfonyl-1,4-phenyleneoxy-1,4-phenylene-isopropylidene-1,4-phenylene), poly-(sulfonyl-1,4-phenyleneoxy-1,4-phenylenesulfonyl-4,4′-biphenylene), and the like; polycarbonates, such as poly(bisphenol A) or poly(carbonyldioxy-1,4-phenyleneisopropylidene-1,4-phenylene), and the like; polyesters, such as poly(ethylene terephthalate), poly(tetramethylene terephthalate), poly(cyclohexylene-1,4-dimethylene terephthalate) or poly(oxymethylene-1,4-cyclohexylenemethyleneoxyterephthaloyl), and the like; polyaryl sulfides, such as poly(p-phenylene sulfide) or poly(thio-1,4-phenylene), and the like; polyimides, such as poly(pyromellitimido-1,4-phenylene), and the like; polyolefins, such as polyethylene, polypropylene, poly(1-butene), poly(2-butene), poly(1-pentene), poly(2-pentene), poly(3-methyl-1-pentene), poly(4-methyl-1-pentene), and the like; vinyl polymers, such as poly(vinyl acetate), poly(vinylidene chloride), poly(vinyl chloride), and the like; diene polymers, such as 1,2-poly-1,3-butadiene, 1,4-poly-1,3-butadiene, polyisoprene, polychloroprene, and the like; polystyrenes; copolymers of the foregoing, such as acrylonitrile-butadiene-styrene (ABS) copolymers, and the like; and the like.

The thermoplastic binders further include ethylenevinyl acetate copolymers (EVA), ultra-high molecular weight polyethylene (UHMWPE), very high molecular weight polyethylene (VHMWPE), nylon, polyethersulfone, ethylene-acrylic acid copolymer, ethylene-methacrylic acid copolymer, ethylene-methylacrylate copolymer, polymethylmethacrylate, polyethylmethacrylate, polybutylmethacrylate, and copolymers/mixtures thereof.

The term “low melt index polymeric material,” as used herein, means a polymeric material having a melt index less than 1.0 g/10 min., as determined by ASTM D 1238 at 190° C. and 15 kg load. The term thus includes both ultra high and very high molecular weight polyethylene.

The terms “cationically charged” and “cationic,” as used herein, mean having a plurality of positively charged groups. The terms “cationically charged” and “positively charged” are thus synonymous and include, but are not limited to, a plurality of quaternary ammonium groups.

The term “functionalized,” as used herein, means including a plurality of functional groups (other than the cationic groups) that are capable of crosslinking when subjected to heat. Such functional groups include, but are not limited to, epoxy, ethylenimino and episulfido. The term “functionalized cationic polymer” thus means a polymer that contains a plurality of positively charged groups and a plurality of at least one further functional group that is capable of being crosslinked by the application of heat. Such polymers include, but are not limited to, epichlorohydrin-functionalized polyamines and epichlorohydrin-functionalized polyamido-amines.

The term “incorporating,” as used herein, means including, such as including a functional element of a device, apparatus or system. Incorporation in a device may be permanent, such as a non-removable filter cartridge in a disposable water filtration device, or temporary, such as a replaceable filter cartridge in a permanent or semi-permanent water filtration device.

Filter performance can be defined in various ways. For the purposes of the instant invention, good filter performance means some or all of the following:
Removal of at least 99.95% of particles greater than 3 μm in size from the source water until the water flow rate has been reduced by approximately 75% from an initial water flow rate;
Reduction of lead concentration to no more than 10 ppb in 100 gallons of source water that has an initial lead concentration of 150 ppb;
Reduction of chloroform concentration to no more than 80 ppb in 100 gallons of source water that has an initial chloroform concentration of 450 ppb.

In general, water moves through gravity flow water filters with head pressures less than 1 psi. Good flow rates for gravity flow water filters with head pressures in this range are rates faster than about 0.20 liters/min (or about 0.05 gallons/min). In general, conventional, loose media, gravity-flow carbon filters have flow rates between about 0.125 liters/minute and 0.250 liters/minute. Conventional carbon block filters vary in their flow rate performance and, as they are usually used in faucet-mount systems, are subject to wider ranges of head pressure due to variations in household water pressures than are loose media filters. Typical carbon block filters can have flow rates around 3.5 liters/min (or about 0.75 gallons/min) with head pressures around 60 psi. In general, water does not flow through most block filters under the low pressure (less than 1 psi) conditions found in gravity flow systems.

As will be appreciated by one having ordinary skill in the art, the gravity flow filters described herein have many advantages. In one embodiment of the invention, the filter, described in detail below, generally contains approximately 20-90 wt % activated carbon particles having a mean particle size in the range of approximately 90-220 μm, and approximately 10-50 wt % low melt index polymeric material (i.e., binder). The low melt index polymeric material can have a melt index less than 1.0 g/10 min. at 190° C. and 15 kg load and a mean particle size in the range of approximately 20-150 μm.

In another embodiment of the invention, the filter contains approximately 10-80 wt % activated carbon particles having a mean particle size in the range of approximately 90-220 μm, approximately 10-50 wt % low melt index polymeric material and approximately 5-40 wt % of an active material. The active material can contain ceramic, zeolite or alumina particles, each having a mean particle size in the range of approximately 20-100 μm, or silica gel.

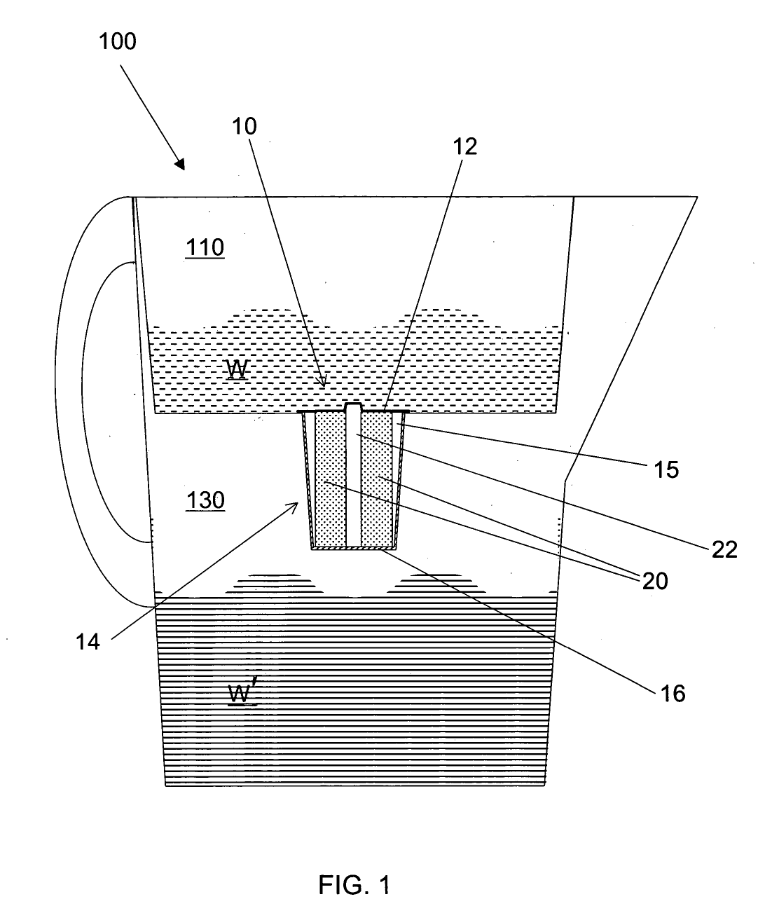

Referring first to FIG. 1, there is a filter cartridge 10 installed in a pour-through water carafe 100. The filter cartridge 10 has a carbon block filter 20 inside. In operation, source water W flowing from upper reservoir 110 to lower reservoir 130 is channeled through a plurality of openings (not shown) in cover 12, directly into interior space 15 of filter cup 14. Inorganic and organic contaminants are removed from the source water W, as the source water W moves through the filter 20, thus transforming the source water W into filtered water W′. The filtered water W′ flows into cavity 22 of the filter 20 and out through bottom 16 of the filter cup 14 into lower reservoir 130.

In an alternative embodiment, source water W flowing from the upper reservoir 110 to the lower reservoir 130 is channeled through a plurality of openings (not shown) in the cover 12, directly into the filter cavity 22. Inorganic and organic contaminants are removed from the source water W, as the source water W moves through the filter 20, thus transforming the source water W into filtered water W′. The filtered water W′ flows from the filter 20 directly out through the bottom 16 of the filter cup 14 and into the lower reservoir 130.

Although a pour-through carafe has been used to illustrate the filter 20, the filter 20 can be employed in combination with any water pitcher, bottle, carafe, tank, or other gravity-flow filtration system. The embodiments of the invention should thus not be construed as being limited in scope to filtering water only in pour-through carafes.

The filter 20 can contain activated carbon that is bonded with a binder to form an integrated, porous, composite, carbon block. The activated carbon can be in the form of particles or fibers. In some embodiments, the filter 20 includes at least one additional active material, such as ceramic or zeolite particles. The active material(s) can also be bound together with the carbon and the binder within the porous composite block.

Activated Carbon

Activated carbon from any source can be used, such as that derived from bituminous coal or other forms of coal, or from pitch, bones, nut shells, coconut shells, corn husks, polyacrylonitrile (PAN) polymers, charred cellulosic fibers or materials, wood, and the like. Activated carbon granules can, for example, be formed directly by activation of coal or other materials, or by grinding carbonaceous material to a fine powder, agglomerating it with pitch or other adhesives, and then converting the agglomerate to activated carbon. Coal-based or wood-based activated carbon can be used in combination or separately, e.g., 90% coconut carbon and 10% bituminous carbon.

In one embodiment of the invention, the mesh size of the activated carbon is approximately 80×325 U.S. mesh. In another embodiment of the invention, the mesh size of the activated carbon is approximately 80×200 U.S. mesh. As reflected in the “Examples” section, although the 80×200 mesh size is less effective in removing contaminants from water than the 80×325 mesh carbon, the 80×200 mesh exhibits a higher filtration rate.

In yet another embodiment of the invention, the mesh size of the activated carbon is approximately 50×200 U.S. mesh. As also reflected in the “Examples” section, the noted mesh size exhibits excellent effectiveness in removing contaminants from water and a very high filtration rate.

In some arrangements, the activated carbon has an average particle size such that it can pass through a screen of 350 mesh or less (e.g., an average particle size of less than about 350 mesh-about 40 μm). In one arrangement, the activated carbon has a mean particle size in the range of 90-220 μm. In another arrangement, the activated carbon has a mean particle size in the range of 150-200 μm.

The activated carbon can also be impregnated or coated with other materials to increase the adsorption of specific species. For example, the activated carbon can be impregnated with citric acid to increase the ability of the activated carbon to adsorb ammonia. Impregnation of the active carbon with hydroxides, such as sodium hydroxide, or other caustic compounds can also be useful for removal of hydrogen sulfide.

Impregnation of the activated carbon with metals, metal oxides, metal hydroxides or metal ions, such as copper sulfate and copper chloride, is believed to be useful for removal of other sulfur compounds. Finally, the activated carbon can also be impregnated with a variety of salts, such as zinc salts, potassium salts, sodium salts, silver salts, and the like. In other arrangements, activated carbon can be modified with reduced nitrogen groups, metal oxides, or other metal compounds suitable for removal of contaminants from water.

In another embodiment of the invention, the carbon content is in the range of approximately 20-90%, by weight. In an alternative embodiment, the carbon content is in the range of approximately 40-80%, by weight. When other actives are included in the filter 20, the carbon content can be in the range of approximately 10-80%, by weight.

Binder

The binder can contain any of the aforementioned binder materials. The binder can be a low melt index polymeric material, as described above. In other arrangements, the binder can contain a higher melt index material, that is, a material with a melt index that is greater than 1.0 g/10 min.

Low melt index polymeric materials having a melt index less than approximately 1.0 g/10 min at 190° C. and 15 kg load, such as VHMWPE or UHMWPE, are well known in the art. Low melt index binders do not flow easily when heated, but become only tacky enough to bind granules together without covering much of the surface of the granules.

In some arrangements, binder materials that have high melt index values, that is, melt indices greater than those of VHMWPE or UHMWPE, such as poly(ethylene-co-acrylic acid) or low density polyethylene, can also be used. Even though high melt index materials can tend to melt and flow when heated, careful choice of binder particle size and processing conditions can make these materials very effective for forming porous composite blocks for water filtration. These binders and their use in water filtration have been disclosed by Taylor et al. in U.S. patent application Ser. No. 10/756,478, filed Jan. 12, 2004, which is included by reference herein.

As will be appreciated by one having ordinary skill in the art, the type of binder used to construct the filter 20 can affect the initial flow rate of water through the filter, since carbon is more hydrophilic than most binders or other actives. Initially, the filter 20 is dry and when it is placed in contact with water, it may or may not absorb the water readily and thus allow for immediate water flow. Filters made with UHMWPE or VHMWPE with a low melt index tend to absorb water more readily than filters made with EVA or LDPE. Also, by maximizing the available surface area of the carbon, one can achieve a carbon block that is hydrophilic and readily absorbs water. As a result, binders that neither flow nor deform significantly when melted, but simply become tacky, maximize the available carbon surface area and thus maximize the water absorptivity of the carbon block. Other binders that have a tendency to melt during processing can also provide a large available carbon surface area when they have very small particle sizes. As discussed in detail in the “Examples” section, this phenomenon has been confirmed by measuring the iodine number and strike-through of carbon blocks made with different binders.

In one embodiment, the binder content is in the range of approximately 5-50%, by weight. In other arrangements, the binder content is in the range of approximately 20-35%, by weight.

In one embodiment of the invention, the binder particles are in the range of approximately 5-150 μm. In an alternative embodiment, the binder particles are in the range of approximately 100-150 μm. In another embodiment, the binder particles are approximately 110 μm.

Actives

One or more additional active materials (or actives) can be included in the carbon block filter. The active(s) can contain ceramic particles, zeolite particles, zirconia, aluminosilicate, silica gel, alumina, metal oxides/hydroxides, inert particles, sand, surface charge-modified particles, clay, pyrolyzed ion-exchange resin and mixtures thereof.

In one embodiment, the actives constitute between about 0.01 wt % and 70 wt % of the porous composite block. In other arrangements, the actives constitute between about 20 wt % and 40 wt % of the porous composite block. In another arrangement, the actives constitute between about 5% and 40%, by weight, of the porous composite block. In another arrangement, the actives constitute between about 10% and 30%, by weight, of the porous composite block.

In one embodiment of the invention, the actives have a mean particle size in the range of approximately 20 to 100 μm. In an alternative embodiment, the actives have a mean particle size in the range of approximately 1 to 50 μm.

Filter Block Dimensions

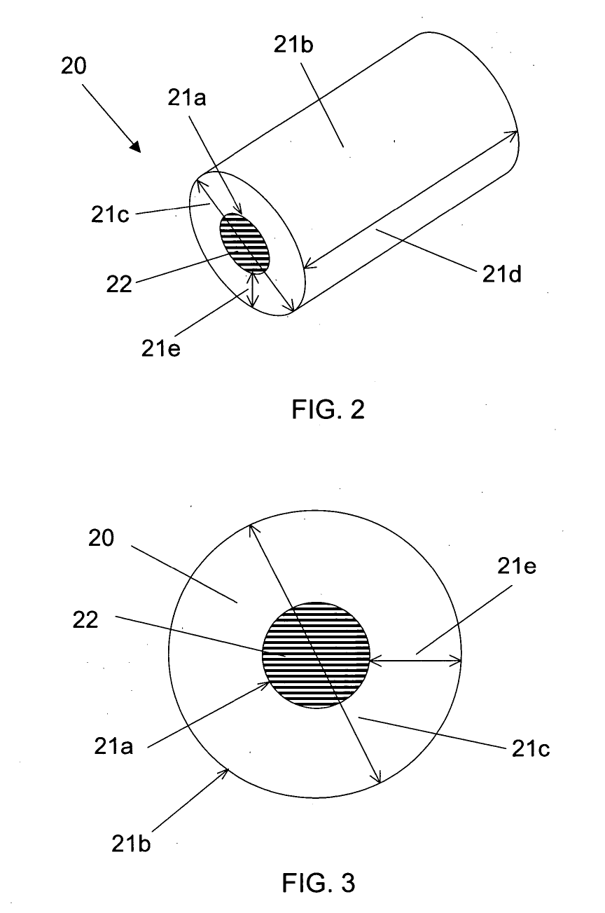

As illustrated in FIGS. 2 and 3, the porous composite block filter 20 can be substantially cylindrical in shape and can have an internal cavity or port 22. The filter 20 also has an internal surface 21a and an external surface 21b. External surface area of the filter 20 is the area of the cylindrical surface formed by external surface 21b. The filter 20 has an outside diameter 21c and a length 21d. Wall thickness 21e is the perpendicular distance between the internal surface 21a and the external surface 21b. Block filters can also have other shapes, such as sheets, solids, cubes, parallelepipeds, etc.

The wall thickness 21e and the external surface 21b area of the carbon block filter can influence the flow rate of water through the filter. Good flow rates and effective contaminant removal can be achieved when the external surface 21b area is between approximately 9 and 46 in². In other arrangements, the external surface area can be in the range of approximately 18 to 30 in². In one embodiment, the wall thickness 21e is in the range of approximately 0.25 to 0.75 in. In other arrangements, the wall thickness 21e is approximately 0.35 to 0.60 in. The filter block 20 can have an outside diameter between about 2.0 and 4.0 in., a length between about 1.0 and 3.0 in. and a wall thickness between about 0.25 and 0.75 in.

Filter Sheets

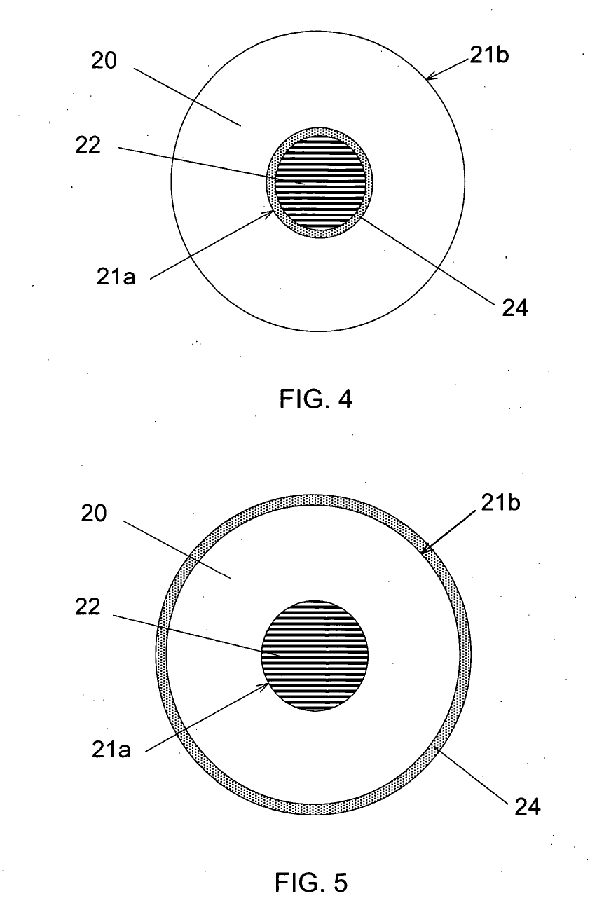

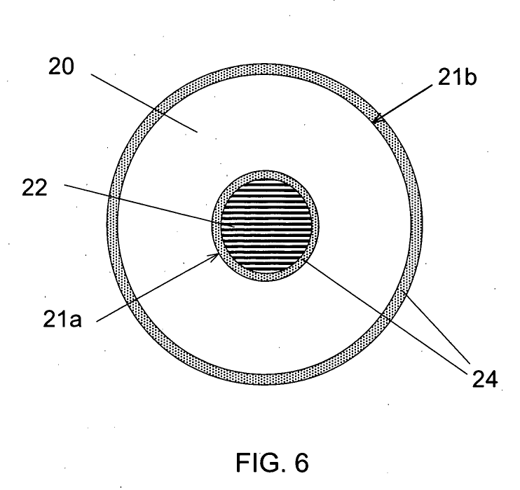

FIGS. 4, 5 and 6, show examples of how filter sheets can be used with a porous composite carbon block. In FIG. 4, a filter sheet 24 has been applied to the internal surface 21a of the block 20. In FIG. 5, a filter sheet 24 has been applied to the external surface 21b of the block 20. In FIG. 6, a filter sheet 24 has been applied to both the internal surface 21a and the external surface 21b of the block 20. The filter sheet 24 can enhance the performance and extend the life of the block filter 29. In one embodiment, for example, the filter sheet 24 is a non-woven material with a 1.0 μm pore size disposed on the internal and/or external surface of filter block to facilitate the removal of microbiological cysts, such as Giardia and Cryptosporidium. In another embodiment, the non-woven material is disposed on the outside surface of the filter block. The non-woven material can capture particles in the range of approximately 5-1.5 μm, thus preventing particles in this size range from clogging the internal porous structure of the carbon block. Use of woven and non-woven filter sheets on filter block surfaces can result in extended filter life. Non-woven materials used in conjunction with filter blocks have been disclosed in U.S. Pat. No. 5,980,743, which is included by reference herein.

The filter sheet can include a woven or non-woven sheet material. As used herein, the term “nonwoven sheet” means a web or fabric having a structure of individual fibers or threads which are interlaid, but not in an identifiable manner as in a knitted or woven fabric. Nonwoven sheets can be prepared by methods that are well known to those having ordinary skill in the art. Examples of such processes include meltblowing, coforming, spinbonding, carding and bonding, air laying, and wet laying.

The filter sheet can also include a nonwoven charge-modified material. As will be appreciated by one having ordinary skill in the art, a nonwoven charge-modified microfiber glass web can be prepared from a fibrous web that incorporates glass fibers having a cationically charged coating thereon. Generally, such microfibers would contain glass fibers having a diameter of about 10 μm or less. The coating typically includes a functionalized cationic polymer that has been crosslinked by heat, i.e., the functionalized cationic polymer has been crosslinked by heat after being coated onto the glass fibers. The coating can also contain a metal oxide or hydroxide.

A fibrous filter can be prepared by a method that includes the steps of providing a fibrous filter having glass fibers, passing a solution of a functionalized cationic polymer crosslinkable by heat through the fibrous filter under conditions sufficient to substantially coat the fibers with the functionalized cationic polymer, and treating the resulting coated fibrous filter with heat at a temperature and for a time sufficient to crosslink the functionalized cationic polymer present on the glass fibers. The functionalized cationic polymer can include an epichlorohydrin-functionalized polyamine or an epichlorohydrin-functionalized polyamido-amine.

When used as a filter medium, the charge-modified microfiber glass material can contain at least about 50 wt % of glass fibers, based on the weight of all fibers present in the filter media. In some embodiments, approximately 100% of the fibers contain glass fibers. When other fibers are present, however, they generally contain cellulosic fibers, i.e., fibers prepared from synthetic thermoplastic polymers, or mixtures thereof.

As indicated above, the terms “cationically charged,” in reference to a coating on a glass fiber, and “cationic,” in reference to the functionalized polymer, mean having a plurality of positively charged groups in the respective coating or polymer. Thus, the terms “cationically charged” and “positively charged” are deemed synonymous. Such positively charged groups include, but are not limited to, a plurality of quaternary ammonium groups.

The term “functionalized” means having a plurality of functional groups, other than the cationic groups, which are capable of crosslinking when subjected to heat. Examples of such functional groups include epoxy, ethylenimino, and episulfido. These functional groups readily react with other groups typically present in the cationic polymer. The “other groups” typically have at least one reactive hydrogen atom and are exemplified by amino, hydroxy, and thiol groups. As will be appreciated by one having ordinary skill in the art, the reaction of a functional group with another group often generates still other groups which are capable of reacting with functional groups. By way of example, the reaction of an epoxy group with an amino group results in the formation of a P-hydroxyamino group.

Thus, the term “functionalized cationic polymer” is meant to include any polymer which contains a plurality of positively charged groups and a plurality of other functional groups that are capable of being crosslinked by the application of heat. Particularly useful examples of such polymers are epichlorohydrin-functionalized polyamines and epichlorohydrin-functionalized polyamido-amines. Other suitable materials include cationically modified starches.

A nonwoven, charge-modified, meltblown material can contain hydrophobic polymer fibers, amphiphilic macromolecules adsorbed onto at least a portion of the surfaces of the hydrophobic polymer fibers, or a crosslinkable, functionalized cationic polymer associated with at least a portion of the amphiphilic macromolecules, in which the functionalized cationic polymer has been crosslinked. The crosslinking can be achieved through the use of a chemical crosslinking agent or by the application of heat.

Amphiphilic macromolecules can include one or more of the following types: proteins, poly(vinyl alcohol), monosaccha rides, disaccharides, polysaccharides, polyhydroxy compounds, polyamines, polylactones, and the like. In some arrangements, the amphiphilic macromolecules contain amphiphilic protein macromolecules, such as globular protein or random coil protein macromolecules. For example, in one embodiment of the invention, the amphiphilic protein macromolecules contain milk protein macromolecules.

Functionalized cationic polymers can contain a polymer that contains a plurality of positively charged groups and a plurality of other functional groups that are capable of being crosslinked by, for example, chemical crosslinking agents or the application of heat. Particularly useful examples of such polymers are epichlorohydrin-functionalized polyamines and epichlorohydrin-functionalized polyamido-amines. Other suitable materials include cationically modified starches.

Nonwoven charge-modified meltblown materials can be prepared by a method that involves providing a fibrous meltblown filter media having hydrophobic polymer fibers, passing a solution containing amphiphilic macromolecules through the fibrous filter under shear stress conditions so that at least a portion of the amphiphilic macromolecules are adsorbed onto at least some of the hydrophobic polymer fibers to give an amphiphilic macromolecule-coated fibrous web, passing a solution of a crosslinkable, functionalized cationic polymer through the amphiphilic macromolecule-coated fibrous web under conditions sufficient to incorporate the functionalized cationic polymer onto at least a portion of the amphiphilic macromolecules to give a functionalized cationic polymer-coated fibrous web in which the functionalized cationic polymer is associated with at least a portion of the amphiphilic macromolecules, and treating the resulting coated fibrous filter with a chemical crosslinking agent or heat. The coated fibrous filter can be treated with heat at a temperature and for a time sufficient to crosslink the functionalized cationic polymer.

Processing

A carbon block filter can be manufactured using conventional manufacturing techniques and apparatus. In one embodiment, the binder, carbon granules, and other actives are mixed uniformly to form a substantially homogeneous blend The blend is then fed into a conventional cylindrical mold that has an upwardly projecting central dowel and heated to a temperature in the range of approximately 175-205° C. Pressure of less than 100 psi is applied to the blend during cooling. After cooling, the resulting porous composite carbon block is removed from the mold and trimmed, if necessary.

As noted above, in the processing of the carbon block, compression can be applied in order to achieve a more consistent and stronger carbon block than can be achieved using a sintering process as commonly practiced in the porous plastics industry. Compression can facilitate good contact between powdered or granular media and binder particles by pressing the powdered media into the binder. Compression can also prevent cracking and shrinkage of the carbon block while the filter is cooling in the mold. Thus, in one embodiment of the invention, a compression that reduces the fill height of the mold in the range of approximately 0%-30% is employed. In some arrangements, the compression reduces the fill height of the mold in the range of approximately 5-20%. In another arrangement no compression is applied.

Filter Cartridge/Filter Assemblies

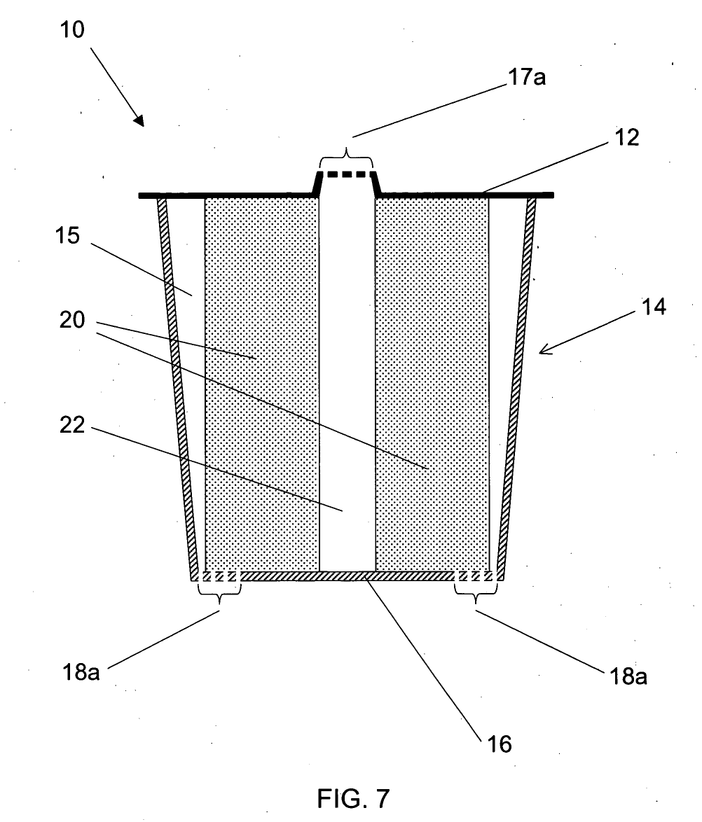

Cylindrical filters as illustrated in FIGS. 2-6 can be employed in most, if not all, gravity-flow filtration cartridges adapted to receive same. FIG. 7 is a schematic cross section of a filter housing or cartridge 10 that contains a porous composite carbon block filter 20, according to an embodiment of the invention. The cartridge includes a cover 12 and a cup 14. The cover 12 can be attached to the cup 14 after the filter 20 is placed inside the cup 14. Within the interior space of the cartridge 10 there is an outer space 15 outside the porous composite carbon block 20 and an inner space 22 within the bore of the porous composite carbon block 20. The cover 12 includes a plurality of entrance openings 17a near the center of the cover 12. The entrance openings 17a are adapted to allow water to enter into the inner space 22. The bottom 16 of the cup 14 includes a plurality of exit openings 18a. The exit openings 18a are adapted to allow water to exit from the outer space 15 and/or the porous composite carbon block 20.

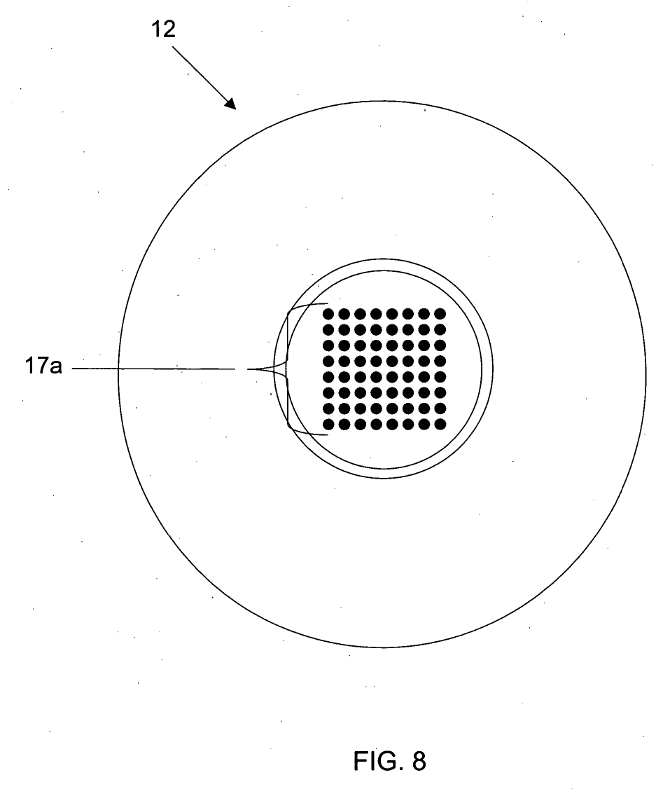

FIG. 8 is a top view of the cover 12 of the filter cartridge 10 of FIG. 7, showing an exemplary embodiment of the invention. In this example, the entrance openings 17a are shown grouped near the center of the cover 12. Although the entrance openings 17a are shown as round holes arranged in a square array, it will be appreciated that other opening shapes, such a slots or slits and other arrangements of the openings, can be employed.

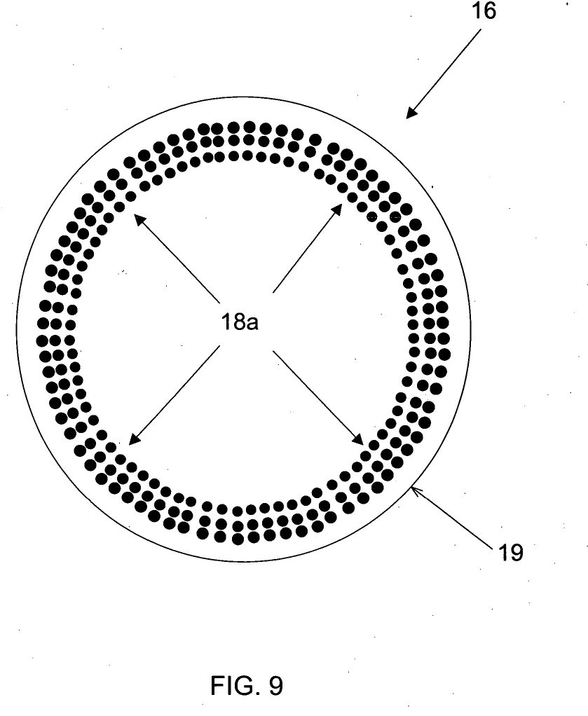

FIG. 9 is a bottom view of the cup 14 of the filter cartridge 10 of FIG. 7, showing an exemplary embodiment of the invention. In this arrangement, the exit openings are distributed in a circle concentric to an outer edge 19 of the cup bottom 16. Although the exit openings 18a are shown as round holes, it will be appreciated that other shapes, such a slots or slits, can be employed.

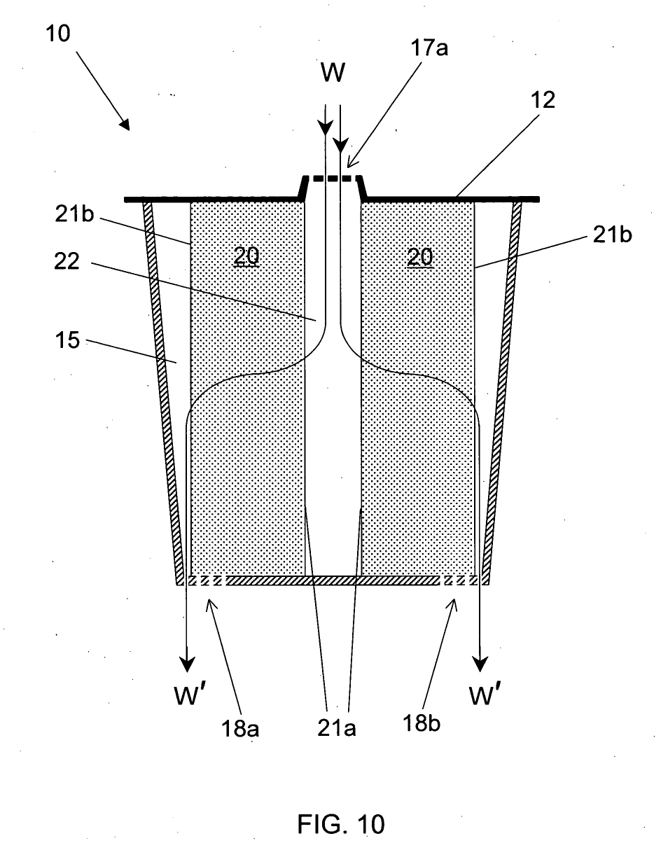

FIG. 10 is a schematic cross section showing a water flow path through the filter cartridge 10 and the carbon block filter 20. When the cap 12 is exposed to a body or flow of source water W, the source water W flows into and through the entrance openings 17a in the cap 12, and enters into the inner space 22 of the filter 20. The water W then flows through an interior wall 21a of the filter 20, out an exterior wall 21b of the filter 20, and into the outer space 15. In passing through the filter 20, the source water W becomes purified water W′. The purified water W′ exits the filter cartridge 10 through the exit openings 18a.

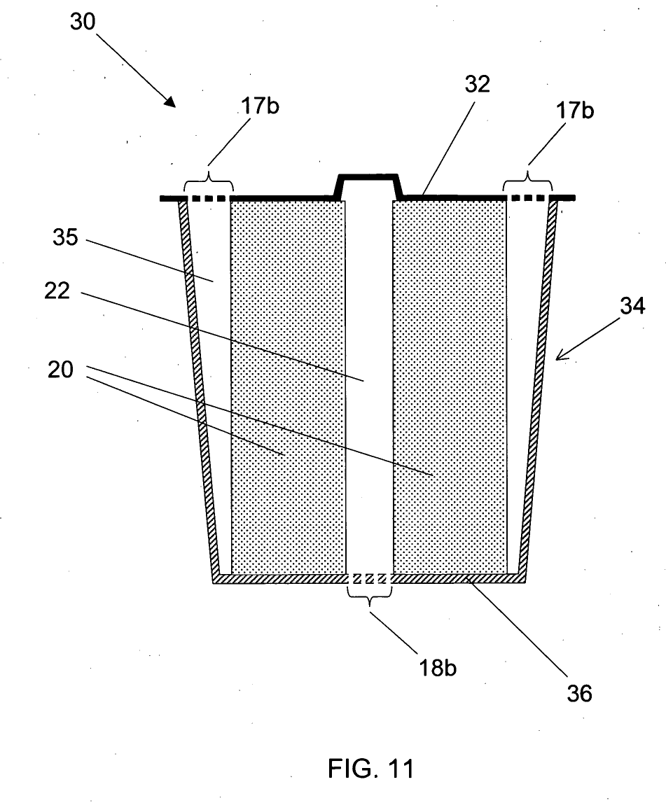

FIG. 11 is a schematic cross section of a filter housing or cartridge 30 that contains a porous composite carbon block filter 20, according to another embodiment of the invention. The cartridge includes a cover 32 and a cup 34. The cover 32 can be attached to the cup 34 after the filter 20 is placed inside the cup 34. Within the interior space of the cartridge 30 there is an outer space 35 outside the porous composite carbon block 20 and an inner space 22 within the bore of the porous composite carbon block 20. The cover 32 includes a plurality of entrance openings 17b near the periphery of the cover 32. The entrance openings 17b are adapted to allow water to enter into the inner space 22. The bottom 36 of the cup 34 includes a plurality of exit openings 18b. The exit openings 18b are adapted to allow water to exit from the inner space 22 and/or the porous composite carbon block 20.

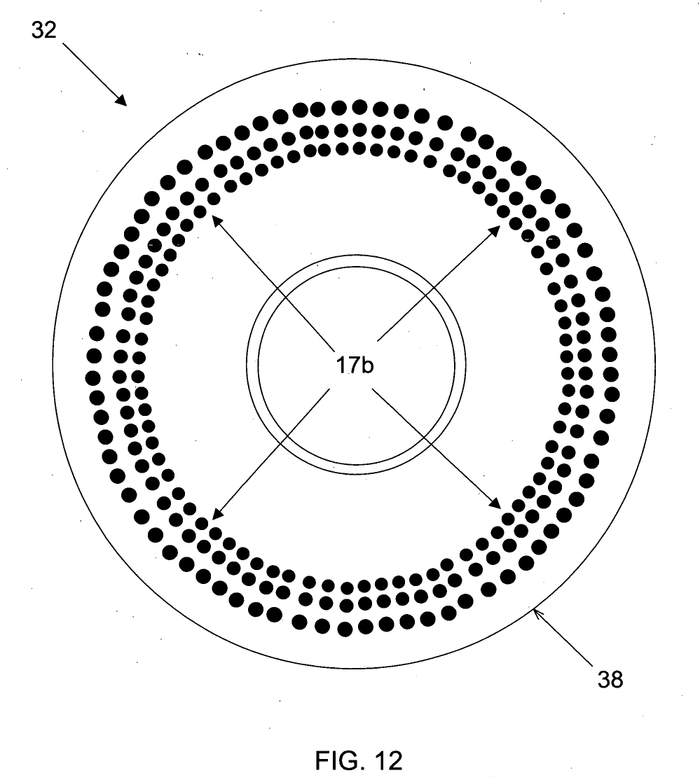

FIG. 12 is a top view of the cover 32 of the filter cartridge 30 of FIG. 11, showing an exemplary embodiment of the invention. In this arrangement, the entrance openings are distributed in a circle concentric with an outer edge 38 of the cover 32. Although the entrance openings 17b are shown as round holes arranged in a square array, it will be appreciated that other opening shapes, such a slots or slits and other arrangements of the openings, can be employed.

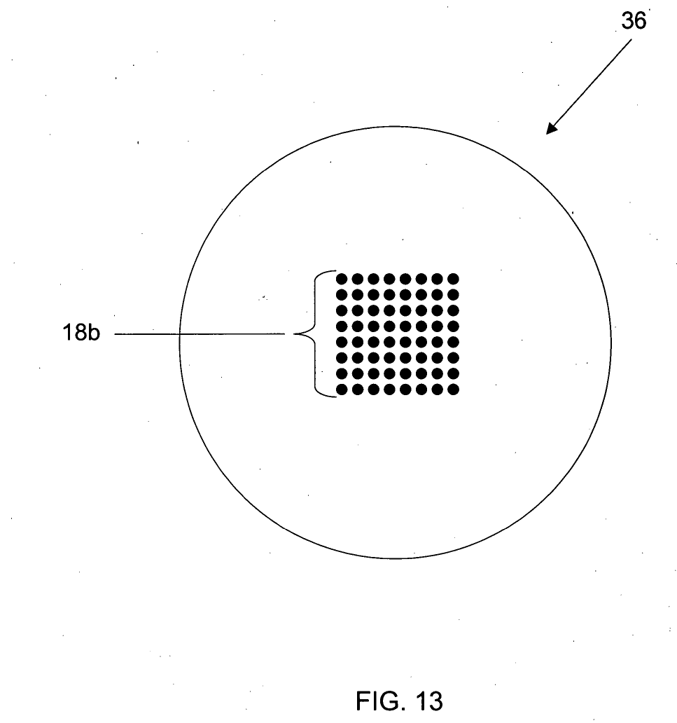

FIG. 13 is a bottom view of the cup 34 of the filter cartridge 30 of FIG. 11, showing an exemplary embodiment of the invention. In this example, the exit openings 18b are shown as grouped near the center of the cup bottom 36. Although the exit openings 18b are shown as round holes, it will be appreciated that other shapes, such a slots or slits, can be employed.

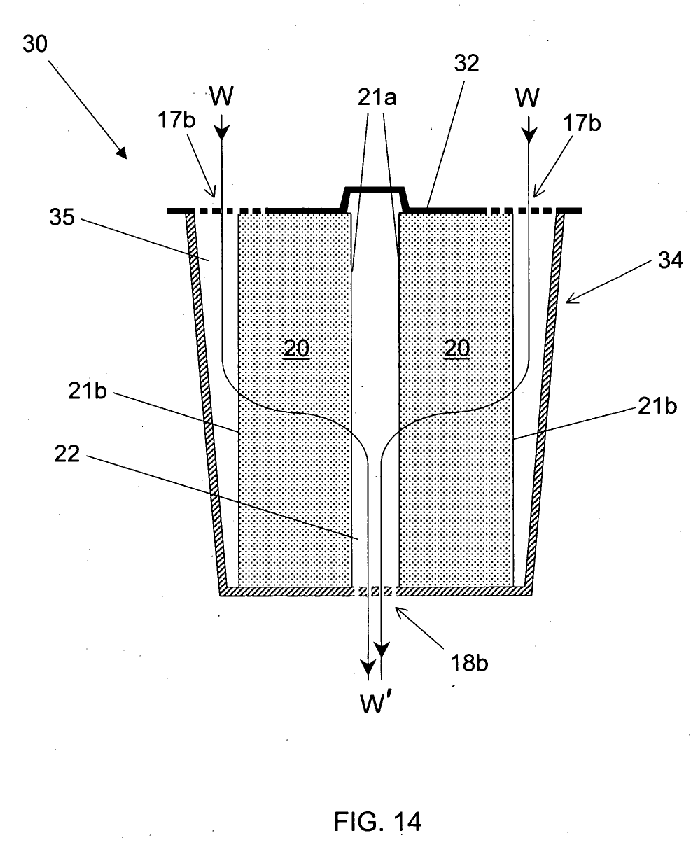

FIG. 14 is a schematic cross section showing a water flow path through the filter cartridge 30 and the carbon block filter 20. When the cap 32 is exposed to a body or flow of source water W, the source water W flows into and through the entrance openings 17b in the cap 32 and enters into the inner space 22 of the filter 20. The water W then flows through an exterior wall 21b of the filter 20, out an interior wall 21a of the filter 20, and into the inner space 22. In passing through the filter 20, the source water W becomes purified water W′. The purified water W′ exits the filter cartridge 30 through the exit openings 18b.

### EXAMPLES

Embodiments of the present invention are further illustrated by the following examples. The examples are for illustrative purposes only and thus should not be construed as limitations in any way.

All scientific and technical terms employed in the examples have the same meanings as understood by one with ordinary skill in the art. Unless specified otherwise, all component or composition percentages are “by weight,” e.g., 30 wt %.

### Example 1

Two carbon block filters comprising approximately 80 wt % 80×200 mesh activated carbon (i.e., coconut shell carbon) and approximately 20 wt % binder were formed to investigate the water absorption characteristics of different binders. In filter #1, the binder was EVA. In filter #2, the binder was VHMWPE.

The degree to which carbon was available in each case to absorb impurities is indicated in the column labeled “percent available carbon.” This was determined by comparing the iodine number for the raw carbon to the iodine number for the bound carbon.

As will be appreciated by one having skill in the art, the iodine number is a number expressing the quantity of iodine absorbed by a substance. Referring now the Table I, the fourth column expresses the iodine number for the raw carbon. The fiftj column expresses the iodine number for the carbon in its bound form, i.e., in a filter block. In each case, the filter block was first produced in accordance with the process described above, and then a portion thereof was ground up for purposes of determining its iodine number.

Conventional sodium thiosulfate titration techniques were used to determine the iodine number in each case. The percentage of available carbon is the bound carbon iodine number divided by the raw carbon iodine number multiplied by 100.

TABLE I

| | | Iodine | Iodine | | | Readily |
|---|---|---|---|---|---|---|
| Filter | Carbon | | No. of | No. of | Available | absorbs |
| Ref. | (C) | Binder | raw C | block | C | water? |
| #1 | ˜80 wt % | ˜20 wt % | 1016 | 633 | 62.3% | No |
| | | EVA | | | | |
| #2 | ˜80 wt % | ˜20 wt % | 1016 | 860 | 84.6% | Yes |
| | | VHMWPE | | | | |

As shown in Table I, the percentage of available carbon is significantly greater in filter #2 where the binder was a very high molecular weight, low melt index polymer. The noted results thus indicate that the use of a very high molecular weight, low melt index polymer can maximize the water absorptivity of carbon block filters employing same.

### Example 2

As is well known, a common measure of the absorbency of a material is called the “strike-through” value. The “strike-through” values are commonly employed in the absorbent article industry (e.g. diapers) to determine how fast a material absorbs water. Strike-through values were thus employed in the instant example to quantify the “wettability” of the carbon block filters. The method employed was as follows: a 1.0 in. internal diameter pipe section was glued to the surfaces of several carbon block filters so that approximately 0.785 in² of the block surface was exposed in the bottom of the pipe. A set quantity of water (i.e., 5.0 ml) was then introduced rapidly into the pipe section. Simultaneously with the introduction of the water, a timer was started. When the carbon block absorbed all the water, the timer was stopped and the absorption time recorded. The time to absorb the 5.0 ml of water was deemed the “strike-through” value for the respective carbon block filter.

Referring now to Table II, there is shown the strike-through data for several different carbon block filters.

TABLE II

| | Carbon | | | | Strike- |
|---|---|---|---|---|---|
| Filter | (Waterlink | | | | Through |
| Ref. | coconut) | Binder | Zeolite | Comp. | (seconds) |
| #3 | ˜65 wt % | ˜20 wt % | ˜15 wt % | 10% | 200 |
| | 80 × 200 mesh | VHMWPE | | | |
| #4 | ˜65 wt % | ˜20 wt % | ˜15 wt % | 20% | 160 |
| | 80 × 200 mesh | VHMWPE | | | |
| #5 | ˜65 wt % | ˜20 wt % | ˜15 wt % | 30% | 229 |
| | 80 × 200 mesh | VHMWPE | | | |
| #6 | ˜65 wt % | ˜20 wt % | ˜15 wt % | 10% | 57 |
| | 80 × 325 mesh | VHMWPE | | | |
| #7 | ˜65 wt % | ˜20 wt % | ˜15 wt % | 20% | 74 |
| | 80 × 325 mesh | VHMWPE | | | |
| #8 | ˜65 wt % | ˜20 wt % | ˜15 wt % | 20% | >2000 |
| | 80 × 325 mesh | EVA | | | |

As reflected in the data set forth in Table II, filter #3, having the 80×200 mesh activated carbon, had a significantly higher strike-through value (˜200 sec) as compared to filter #6, having a 80×325 mesh carbon. Filter #6 was thus deemed more “wettable” than filter # 3.

The strike-through value for filter #8, having an EVA binder, was also significantly greater than filters #3-#7, which have the VHMWPE binder. Filters #3-#7 were thus more wettable than filter #8.

The noted strike-through data further indicate that carbon block filters having fine carbon particle sizes and subjected to low compression exhibit greater wettability than those that have a more coarse carbon particle size and higher compression. Further, carbon block filters having high molecular weight binders, such as VHMWPE, provide significantly greater wettablity as compared to an EVA binder.

It should be noted that filters that do not absorb water readily (e.g., filter #8) can still provide the benefits of fast flow and high contaminant reduction. In order to get such a filter to absorb water and begin flowing, initially water can be forced through the carbon block under pressures of 1 to 10 psi to wet the internal surfaces of the block. After the pressure conditioning step, the filters can flow just as fast as filters that have a low “strike-through” value. The noted conditioning step can be performed at the manufacturing facility and the filter sealed into a water tight bag or it can be performed by the consumer with a special adapter to connect the filter to a standard household faucet.

### Example 3

The porosity of the carbon block filter is also critical in the performance and flow rate of the carbon block filters. The porosity of the finished carbon block is determined mainly by the particle sizes of the raw materials and by the amount of compression exerted on the block during the manufacturing process. As discussed below, smaller particles and higher compression can each result in lower porosity.

In order to investigate the porosity of the carbon block filters, carbon block filters of approximately 65 wt % activated carbon, 20 wt % EVA or VHMWPE binders and 15 wt % zeolite were prepared in accordance with procedures described herein.

Referring to Table III, porosity data for the noted filters are shown. The median pore diameter was determined by mercury porosimetry.

TABLE III

| | | | | | Vol. Median | Filter |
|---|---|---|---|---|---|---|
| | | | | | Pore Dia. | Flow Rate |
| Filter Ref. | Carbon | Binder | Zeolite | Comp. | (μm) | (liter/min) |
| #9 | ˜65 wt % | ˜20 wt % | ˜15 wt % | 20% | 45.39 | 0.6 |
| | 80 × 200 mesh | EVA | | | | |
| #10 | ˜65 wt % | ˜20 wt % | ˜15 wt % | 20% | 12.04 | 0.13 |
| | 80 × 325 mesh | EVA | | | | |
| #11 | ˜65 wt. % | ˜20 wt % | ˜15 wt % | 20% | 26.00 | 0.70 |
| | 80 × 200 mesh | VHMWPE | | | | |
| #12 | ˜65 wt. % | ˜20 wt. % | ˜15 wt. % | 20% | 9.01 | 0.21 |
| | 80 × 325 mesh | VHMWPE | | | | |

The porosity data indicate that, for a given binder, the larger the volume median pore diameter, the higher the resulting flow rate of the filter. It should be noted that filter #11 had a higher flow rate than filter #9 and filter #12 had a higher flow rate than filter #10. These respective filter sets had identical filter formulations and compression but different binder types. Therefore, it can reasonably be concluded that higher flow rates can be achieved with a VHMWPE binder than with an EVA binder.

Furthermore, filters #11 and #12 had smaller volume median pore diameters than filters #9 and #10, respectively. However, the flow rates of filters #11 and #12 were still higher than #9 and #10, respectively.

Thus, a balance between volume median pore diameter and binder can (and should) be achieved to realize gravity flow rates between about 0.125 and 0.250 liters/minute.

### Example 4

Three carbon block filters were formed in accordance with procedures described herein. Each filter had an outside diameter of 2.75 inches, a wall thickness of 0.42 inches, and a length of 3.0 in. The composition of each filter was ˜65 wt % 80×200 mesh activated carbon, 20 wt % EVA binder and 15 wt % zeolite. The compression employed was approximately 20%.

Each carbon block filter was assembled into a filtration cartridge having an “inward flow” configuration, as shown in FIGS. 11-14. The filters were then tested for chlorine, lead—pH8.5 and VOC's to 300 liters in a carafe system in accordance with NSF standards 42 and 53. The results of the tests are set forth in Table IV.

TABLE IV

| | Head | | | Pb | VOC |
|---|---|---|---|---|---|
| | Pressure | Flow rate | Cl reduction | reduction | reduction |
| Filter Ref. | (psi) | (liter/min.) | (%) | (%) | (%) |
| #13 | 0.15 | 0.65 | >98% | | |
| #14 | 0.15 | 1.1 | | 99% | |
| #15 | 0.15 | 0.60 | | | 99% |

The data set forth in Table IV shows that filters #13-#15 exhibited superior filtration performance, removing virtually all of the chlorine, lead and VOC's, respectively, to 300 liter. The flow rates for the noted filters were also 3-5 times greater than conventional gravity flow filters.

### Example 5

Three similarly dimensioned gravity flow carbon block filters having about 68 wt % 80×200 mesh activated carbon, 22 wt % VHMWPE binder and 10 wt % zeolite were formed in accordance with procedures described herein.

Each carbon block filter was assembled into a filtration cartridge, as shown in FIGS. 11-14, having an “inward flow” configuration. The filters were then tested in a carafe system in accordance with NSF standards 42 and 53 for chlorine, lead pH8.5 and VOC's to 300 liters. The results of the tests are set forth in Table V.

TABLE V

| | Head | | | | |
|---|---|---|---|---|---|
| Filter | Pressure | Flow rate | Cl reduction | Pb reduction | VOC reduction |
| Ref. | (psi) | (liter/min) | (%) | (%) | (%) |
| #16 | 0.15 | 0.85 | >98% | — | — |
| #17 | 0.15 | 0.90 | — | 99% | — |
| #18 | 0.15 | 0.95 | — | — | 99% |

The results indicate that using a VHMWPE binder instead of an EVA binder yields higher average flow rates, while not affecting the contaminant removal capability of the filter.

### Example 6

A similarly dimensioned gravity flow carbon block filter having the following composition was formed: about 68 wt % 80×200 mesh activated carbon, 22 wt % VHMWPE binder and 10 wt % zeolite.

The carbon block filter was initially assembled into a filtration cartridge having an “inward flow configuration,” as illustrated in FIGS. 11-14. The filter was then tested in a carafe system with an initial head pressure of 0.15 psi to assess the water flow rate.

The same carbon block filter was then assembled into a filtration cartridge having an “outward flow configuration,” as illustrated in FIGS. 7-10. The filter was then similarly tested in a carafe system with an initial head pressure of 0.15 psi. to assess the water flow rate.

The results of this comparative study are shown in Table VI.

TABLE VI

| | Flow Rate |
|---|---|
| Cartridge Type | (liter/min) |
| Inward flow configuration | 1.1 |
| Outward flow configuration | 0.85 |

The data clearly reflects that the flow rate of the inward flow configuration is significantly faster than the flow rate of the outward flow configuration.

Without departing from the spirit and scope of this invention, one of ordinary skill can make various changes and modifications to the invention to adapt it to various usages and conditions. As such, these changes and modifications are properly, equitably, and intended to be, within the full range of equivalence of the following claims.

We claim:

1. A carbon block filter, comprising:
approximately 20-90 wt % activated carbon particles, the activated carbon particles having a mean particle size between approximately 90 and 220 μm; and
approximately 5-50 wt % polymeric material binder, the binder material interspersed with the activated carbon particles.

2. The carbon block filter of claim 1, further comprising approximately 5-40 wt % additional active material.

3. The carbon block filter of claim 1, wherein the activated carbon particles comprise approximately 40-80 wt % of the carbon block filter.

4. The carbon block filter of claim 1, wherein the activated carbon particles have a mean particle size between approximately 150 and 200 μm.

5. The carbon block filter of claim 1, wherein the activated carbon particles have a mesh size of approximately 80×325 mesh.

6. The carbon block filter of claim 1, wherein the activated carbon particles have a mesh size of approximately 80×200 mesh.

7. The carbon block filter of claim 1, wherein the activated carbon particles have a mesh size of approximately 50×200 mesh.

8. The carbon block filter of claim 1, wherein the binder material comprises between approximately 20 and 35 wt % of the carbon block filter.

9. The carbon block filter of claim 1, wherein the binder material has a melt index <1 g/10 min at 190° C. and 15 kg load.

10. The carbon block filter of claim 1, wherein the binder material is selected from the group consisting of polyethylene homopolymers, modified polyethylene homopolymers, ethylene copolymers, ethylene-based ion-containing copolymers, fluoropolymers, nylon, polypropylene, and magnesium cements.

11. The carbon block filter of claim 1, wherein the binder material comprises particles having a mean particle size between approximately 20 and 150 μm.

12. The carbon block filter of claim 11, wherein the binder material comprises particles having a mean particle size between approximately 100 and 150 μm.

13. The carbon block filter of claim 1, wherein the activated carbon particles are impregnated with citric acid.

14. The carbon block filter of claim 1, wherein the activated carbon particles are impregnated with a hydroxide.

15. The carbon block filter of claim 14, wherein the hydroxide comprises sodium hydroxide.

16. The carbon block filter of claim 1, wherein the activated carbon particles are impregnated with a metal.

17. The carbon block filter of claim 1, wherein the activated carbon particles are impregnated with a metal oxide.

18. The carbon block filter of claim 1, wherein the activated carbon particles are impregnated with a metal ion.

19. The carbon block filter of claim 18, wherein the metal ion is selected from the group consisting of copper sulfate and copper chlorine.

20. The carbon block filter of claim 1, wherein the activated carbon particles are impregnated with a salt selected from the group consisting of zinc salt, potassium salt, sodium salt, silver salt and combinations thereof.

21. The carbon block filter of claim 1, wherein the carbon block filter has an inside surface and an outside surface.

22. The carbon block filter of claim 21, further comprising a filter sheet, the filter sheet proximate a surface selected from the group consisting of the inside surface, the outside surface and combinations thereof.

23. The carbon block filter of claim 22, wherein the filter sheet comprises a non-woven web.

24. The carbon block filter of claim 23, wherein the non-woven web comprises a non-woven, charge-modified, microfiber glass web.

25. The carbon block filter of claim 23, wherein the non-woven web comprises a non-woven, charge-modified, melt blown web.

26. The carbon block filter of claim 1 further comprising a cartridge containing a cup portion and a cover portion, in which cartridge, the carbon block filter can be positioned.

27. A carbon block filter, comprising:
approximately 10-80 wt % activated carbon particles, the activated carbon particles having a mean particle size between 90 and 220 μm;
approximately 10-50 wt % binder material; and
approximately 5-40 wt % additional active material.

28. The carbon block filter of claim 27, wherein the additional active material comprises between 10 and 30 wt % of the carbon block filter.

29. The carbon block filter of claim 27, wherein the additional active material comprises particles having a mean particle size between approximately 20 and 100 μm.

30. The carbon block filter of claim 27, wherein the active material comprises particles having a mean particle size between approximately 1 and 50 μm.

31. The carbon block filter of claim 27, wherein the active material comprises at least one material selected from the group consisting of zeolite particles, ceramic particles, alumina particles, and silica gel.

32. A gravity-flow system for treating water, comprising:
a container having a source water compartment than can hold source water and a treated water compartment that can hold treated water;
a cartridge in communication with both the source water compartment and the treated water compartment, the cartridge providing a path through which water can flow from the source water compartment to the treated water compartment; and
a carbon block filter disposed within the cartridge, the carbon block filter comprising:
approximately 20-90 wt % activated carbon particles, the activated carbon particles having a mean particle size between approximately 90 and 220 μm; and
approximately 5-50 wt % polymeric material binder, the binder material interspersed with the activated carbon particles.

33. The system of claim 32 wherein the water has an average flow rate of at least 0.20 liters per minute through the system with a head pressure of between approximately 0.1 and 1.0 psi.

34. The system of claim 33 wherein the filter can remove at least 99.95% of particles greater than 3 μm in size from the source water until the water flow rate has been reduced by approximately 75% from an initial water flow rate.

35. The system of claim 32 wherein the filter can reduce lead concentration to no more than 10 ppb in 100 gallons of source water that has an initial lead concentration of 150 ppb.

36. The system of claim 32 wherein the filter can reduce chloroform concentration to no more than 80 ppb in 100 gallons of source water that has an initial chloroform concentration of 450 ppb.
